(19) United States
(12) Patent Application Publication
(10) Pub. No.: US 2024/0405847 A1
(43) Pub. Date: Dec. 5, 2024

(54) WIRELESS RELAY SYSTEM, AND WIRELESS RELAY METHOD

(71) Applicant: NIPPON TELEGRAPH AND TELEPHONE CORPORATION, Tokyo (JP)

(72) Inventors: Yu ONO, Musashino-shi, Tokyo (JP); Tatsuya NAKATANI, Musashino-shi, Tokyo (JP); Toshifumi MIYAGI, Musashino-shi, Tokyo (JP)

(73) Assignee: NIPPON TELEGRAPH AND TELEPHONE CORPORATION, Tokyo (JP)

(21) Appl. No.: 18/699,334

(22) PCT Filed: Nov. 1, 2021
(86) PCT No.: PCT/JP2021/040265

§ 371 Date: Apr. 8, 2024

(51) Int. Cl. H04B 7/15; H04W 16/26

(52) U.S. Cl. CPC H04B 7/15; H04W 16/26

(57) ABSTRACT

A wireless relay apparatus includes a first software radio device that performs radio communication with a radio control device and a second software radio device that performs radio communication with a radio terminal. The first software radio device captures, as iq data, a radio signal received from the radio control device, transfers the captured iq data to the second software radio device in real time, converts the iq data transferred from the second software radio device into a radio signal, and transmits the radio signal to the radio control device. The second software radio device captures, as iq data, a radio signal received from the radio terminal, transfers the captured iq data to the first software radio device in real time, converts the iq data transferred from the first software radio device into a radio signal, and transmits the radio signal to the radio terminal.

### TECHNICAL FIELD

The present disclosure relates to a wireless relay system and a wireless relay method utilizing a software radio technology.

### BACKGROUND ART

Patent Literature 1 proposes a technology of detecting the presence or absence of connection of a lower terminal in a relay apparatus that connects radio terminals which are under control of the relay apparatus and pausing a connection unit to save power when there is no connection.

### CITATION LIST

### Patent Literature

Patent Literature 1: JP 2012-010281 A

### SUMMARY

### Technical Problem

In the technology of Patent Literature 1, it is difficult to efficiently suppress power consumption depending on a situation such as a case where there are a plurality of relay apparatuses or a case where there are a large number of lower terminals.

The present disclosure has been made in view of the above-described problem. Objects of the present disclosure are to provide a wireless relay system and a wireless relay method by which power consumption can be efficiently suppressed.

### Solution to Problem

A wireless relay system according to an aspect of the present disclosure is a wireless relay system including a plurality of radio relay apparatuses that relay radio communication. The radio relay apparatus includes a first software radio function unit that performs radio communication with a radio control device and a second software radio function unit that performs radio communication with a radio terminal which is under control of the radio control device. The first software radio function unit captures, as iq data, a radio signal received from the radio control device, transfers the captured iq data to the second software radio function unit in real time, converts the iq data transferred from the second software radio function unit into a radio signal, and transmits the radio signal to the radio control device. The second software radio function unit captures, as iq data, a radio signal received from the radio terminal, transfers the captured iq data to the first software radio function unit in real time, converts the iq data transferred from the first software radio function unit into a radio signal, and transmits the radio signal to the radio terminal. The plurality of radio relay apparatuses include an aggregating radio relay apparatus and a radio relay apparatus other than the aggregating radio relay apparatus. The aggregating radio relay apparatus includes a first transfer destination control unit that controls the first software radio function unit included in the aggregating radio relay apparatus to transfer a data signal to and from the second software radio function unit included in the other radio relay apparatus that is not the aggregating radio relay apparatus, and a first monitor unit that activates the first transfer destination control unit when a predetermined condition is satisfied. The radio relay apparatus that is not the aggregating radio relay apparatus includes a second transfer destination control unit that controls the second software radio function unit included in the radio relay apparatus to transfer a data signal to and from the first software radio function unit included in the aggregating radio relay apparatus, instead of the first software radio function unit included in the radio relay apparatus that is not the aggregating radio relay apparatus, and a second monitor unit that activates the second transfer destination control unit when a predetermined condition is satisfied.

A wireless relay method according to another aspect of the present disclosure is a wireless relay method performed by a plurality of radio relay apparatuses including a first software radio function unit that performs radio communication with a radio control device and a second software radio function unit that performs radio communication with a radio terminal which is under control of the radio control device. The wireless relay method includes: a first transfer step of capturing, as iq data, a radio signal received by the first software radio function unit from the radio control device and transferring the captured iq data to the second software radio function unit in real time; a second transfer step of capturing, as iq data, a radio signal received by the second software radio function unit from the radio terminal and transferring the captured iq data to the first software radio function unit in real time; a first transmission step of converting the iq data transferred in the second transfer step into a radio signal and transmitting the radio signal to the radio control device; a second transmission step of converting the iq data transferred in the first transfer step into a radio signal and transmitting the radio signal to the radio terminal; a first transfer destination control step of controlling the first software radio function unit included in an aggregating radio relay apparatus among the plurality of radio relay apparatuses to transfer a data signal to and from the second software radio function unit included in the other radio relay apparatus that is not the aggregating radio relay apparatus, when a predetermined condition is satisfied; and a second transfer destination control step of controlling the second software radio function unit included in the radio relay apparatus that is not the aggregating radio relay apparatus to transfer a data signal to and from the first software radio function unit included in the aggregating radio relay apparatus instead of the first software radio function unit included in the radio relay apparatus that is not the aggregating radio relay apparatus when a predetermined condition is satisfied.

### Advantageous Effects

According to the wireless relay system and the wireless relay method according to the present disclosure, power consumption can be efficiently suppressed.

### BRIEF DESCRIPTION OF DRAWINGS

FIG. 1 is a diagram schematically illustrating a configuration of a radio relay system (wireless relay system) according to Embodiment 1.

FIG. 2 is a diagram schematically illustrating a configuration of a radio relay apparatus according to Embodiment 1.

FIG. 3 is a block diagram illustrating a configuration example of a software radio device constituting the radio relay apparatus according to Embodiment 1.

FIG. 4 is a diagram schematically illustrating an operation of the radio relay system (wireless relay system) in a low power consumption function in Embodiment 1.

### DESCRIPTION OF EMBODIMENTS

Hereinafter, embodiments will be described with reference to the accompanying drawings. In this disclosure, redundant description will be simplified or omitted as appropriate. The present invention is not limited to the following embodiments. The present invention may include various modifications and combinations of configurations disclosed by the following embodiments without departing from the spirit of the present invention.

### Embodiment 1

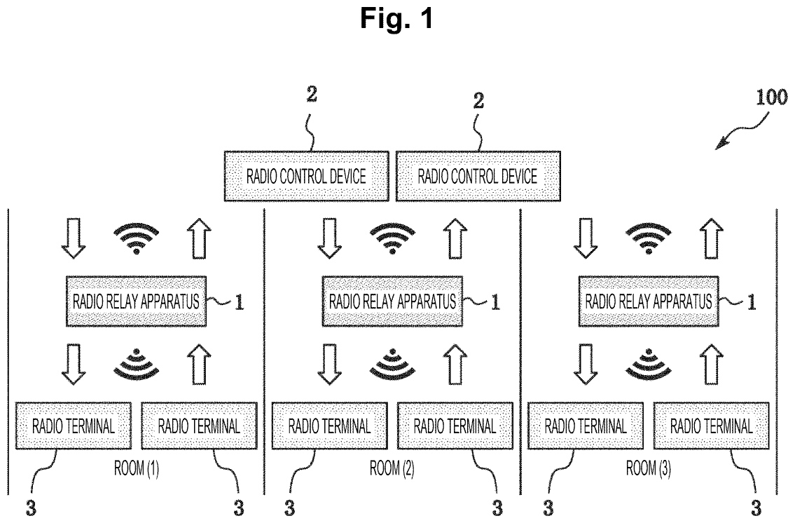

FIG. 1 is a diagram schematically illustrating a configuration of a radio relay system 100 (wireless relay system) according to Embodiment 1. The radio relay system 100 is a system that relays radio communication between an upper radio control device 2 and a radio terminal 3 which is under control of the radio control device 2. The radio relay system 100 can be used in various types of radio communication in the mobile communication field, the IoT field, or the like. The radio relay system 100 can also be used, for example, in a local area network or the like in a large-scale commercial facility or the like.

As illustrated in FIG. 1, a plurality of radio control devices 2 may be provided. Similarly, a plurality of radio terminals 3 may also be provided. In addition, the plurality of radio terminals 3 may be disposed in different rooms, respectively, as illustrated in FIG. 1.

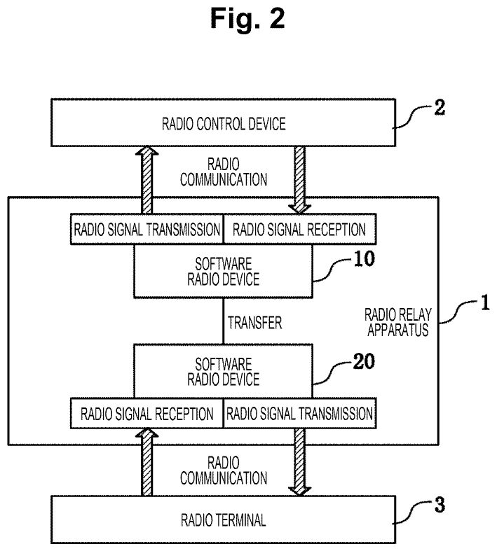

The radio relay system 100 according to this embodiment includes a plurality of radio relay apparatuses 1 that relay radio communication. FIG. 2 is a diagram schematically illustrating a configuration of the radio relay apparatus 1 according to Embodiment 1. The radio relay apparatus 1 according to this embodiment includes a first software radio device 10 and a second software radio device 20. Further, the radio relay apparatus 1 may include at least two software radio devices. The radio relay apparatus 1 may include three or more software radio devices. The number of software radio devices constituting the radio relay apparatus 1 can be appropriately set depending on a frequency band of radio communication to be relayed, a required transfer speed, and the like. The software radio devices are connected by a line that enables high-speed data communication to be performed. Each software radio device is connected by, for example, a UTP cable or an optical cable. Alternatively, each software radio device may be connected by a coaxial cable or the like.

The first software radio device 10 corresponds to a first software radio function unit according to this disclosure. The second software radio device 20 corresponds to a second software radio function unit according to this disclosure. The first software radio function unit and the second software radio function unit may be configured as one software radio device having the same housing. That is, the radio relay apparatus 1 configured to include the first software radio device 10 and the second software radio device 20 in this embodiment may be configured as one software radio device having the same housing. In this case, two input ports and two output ports may be provided in the same housing.

The first software radio device 10 performs radio communication with the radio control device 2. The second software radio device 20 performs radio communication with the radio terminal 3.

The first software radio device 10 captures, as iq data, a radio signal received from the radio control device 2. The first software radio device 10 transfers the captured iq data to the second software radio device 20 in real time over a high-speed line.

On the other hand, the second software radio device 20 captures, as iq data, a radio signal received from the radio terminal 3. The second software radio device 20 transfers the captured iq data to the first software radio device 10 in real time over a high-speed line.

The first software radio device 10 converts the iq data transferred from the second software radio device 20 into a radio signal and transmits, as a radio wave, the radio signal to the radio control device 2. The second software radio device 20 converts the iq data transferred from the first software radio device 10 into a radio signal and transmits, as a radio wave, the radio signal to the radio terminal 3.

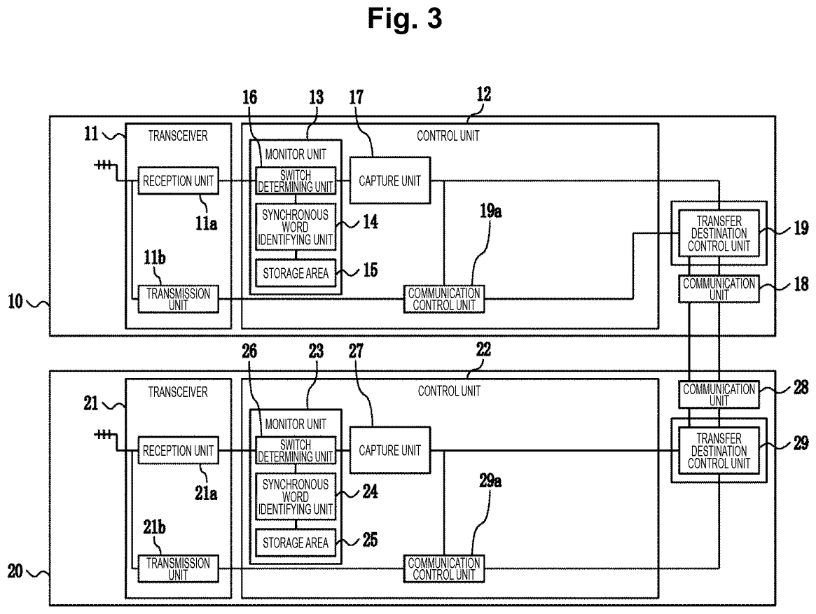

FIG. 3 is a block diagram illustrating a configuration example of the software radio device constituting the radio relay apparatus 1 according to Embodiment 1. As an example, the first software radio device 10 includes a transceiver 11 that performs radio communication with the radio control device 2, and a control unit 12 that implements various functions of the first software radio device 10. As an example, the second software radio device 20 includes a transceiver 21 that performs radio communication with the radio terminal 3, and a control unit 22 that implements various functions of the second software radio device 20.

The transceiver 11 is configured to include a reception unit 11a that receives a signal from the radio control device 2 and a transmission unit 11b that transmits a signal to the radio control device 2. The transceiver 21 is configured to include a reception unit 21a that receives a signal from the radio terminal 3 and a transmission unit 21b that transmits a signal to the radio terminal 3.

The control unit 12 includes a monitor unit 13 that implements a radio signal monitoring function. The monitor unit 13 is configured to include, for example, a synchronous word identifying unit 14 that identifies a synchronization word, a storage area 15, and the like. In addition, the control unit 12 includes a capture unit 17 that implements a radio signal capture function. The capture unit 17 captures, as iq data, the radio signal received by the transceiver 11 and transfers the captured iq data to the outside in real time. The capture unit 17, for example, transfers the iq data to the second software radio device 20 via a communication unit 18.

The control unit 22 includes a monitor unit 23 that implements a radio signal monitoring function. The monitor unit 23 is configured to include, for example, a synchronous word identifying unit 24 that identifies a synchronization word, a storage area 25, and the like. In addition, the control unit 22 includes a capture unit 27 that implements a radio signal capture function. The capture unit 27 captures, as iq data, a radio signal received by the transceiver 21 and transfers the captured iq data to the outside in real time. The capture unit 27, for example, transfers the iq data to the first software radio device 10 via a communication unit 28.

The radio relay apparatus 1 receives and captures a radio signal within a designated frequency band. In this embodiment, it is possible to realize real-time capture and flexible change of the frequency band of a capture target by utilizing the characteristics of software defined radio.

The software radio device constituting the radio relay apparatus 1 can identify a synchronization word in a frame constituting a radio signal transmitted from a radio device such as the radio control device 2 and the radio terminal 3. The frame includes a preamble, a synchronization word, a PHY header, a physical layer data payload, and an FCS. By identifying the synchronization word, the software radio device can efficiently capture only the frequency band used by the radio device that is a relay target.

According to the radio relay apparatus 1 and the software radio devices constituting the radio relay apparatus 1 which are configured as described above, capture and transfer of the radio signal enable relay between various types of radio apparatuses to be realized. According to this embodiment, the type of the radio device capable of relaying is not limited by the frequency, the radio standards, or the installation locations. In addition, according to this embodiment, for example, the radio terminal 3 at a remote location can be accommodated in the radio control device 2.

In addition, the radio relay system 100 according to this embodiment has a low power consumption function. The low power consumption function is a function of reducing the power consumption of a radio relay apparatus other than those set as an aggregating radio relay apparatus among the plurality of radio relay apparatuses 1. The radio relay apparatus 1 that is the aggregating radio relay apparatus and the radio relay apparatus 1 that is not the aggregating radio relay apparatus are set in advance.

In this embodiment, the radio relay apparatus 1 serving as the aggregating radio relay apparatus includes a transfer destination control unit 19 that controls the first software radio device 10 included in the aggregating radio relay apparatus to transfer a data signal to and from the second software radio device 20 included in the other radio relay apparatus 1 that is not the aggregating radio relay apparatus. In addition, the other radio relay apparatus 1 that is not the aggregating radio relay apparatus includes a transfer destination control unit 29 that controls the second software radio device 20 included in the radio relay apparatus 1 to transfer a data signal to and from the first software radio device 10 included in the aggregating radio relay apparatus instead of the first software radio device 10 included in the radio relay apparatus 1. The transfer destination control unit 19 is mounted on the first software radio device 10, for example. The transfer destination control unit 29 is mounted on the second software radio device 20, for example.

In this embodiment, the monitor unit 13 activates the transfer destination control unit 19 when a predetermined condition is satisfied. The monitor unit 23 activates the transfer destination control unit 29 when a predetermined condition is satisfied. For example, the monitor unit 13 activates the transfer destination control unit 19 when the current time is in a time zone registered in the storage area 15 in advance. Similarly, for example, the monitor unit 23 activates the transfer destination control unit 29 when the current time is in a time zone registered in the storage area 25 in advance. Examples of the time zone include a nighttime zone in which communication traffic is small. Alternatively, for example, the transfer destination control unit 19 and the transfer destination control unit 29 may be activated when only the radio terminal 3 that generates a signal including a synchronization word registered in advance in the storage area 15 and the storage area 25 among the plurality of radio terminals 3 is in a situation of communicating with the radio relay apparatus 1. The predetermined condition for activating the transfer destination control unit 19 and the transfer destination control unit 29 can be optionally set. As an example, the monitor unit 13 includes a switch determining unit 16 that determines a condition for activating the transfer destination control unit 19. As an example, the monitor unit 23 includes a switch determining unit 26 that determines a condition for activating the transfer destination control unit 29.

When the transfer destination control unit 19 of the aggregating radio relay apparatus and the transfer destination control unit 29 of the radio relay apparatus 1 that is not the aggregating radio relay apparatus are activated, an operation of the radio relay system 100 in the above-described low power consumption function is executed. Further, monitoring by the monitor unit 13 and the monitor unit 23 is continued even during the operation in the low power consumption function. When the time is in the time zone registered in advance in the storage area 15 and the storage area 25, during the operation in the low power consumption function, or when the radio relay apparatus 1 detects a radio signal including a specific synchronization word registered in advance in the storage area 15 and the storage area 25, the return from the low power consumption function to the usual relay function is performed.

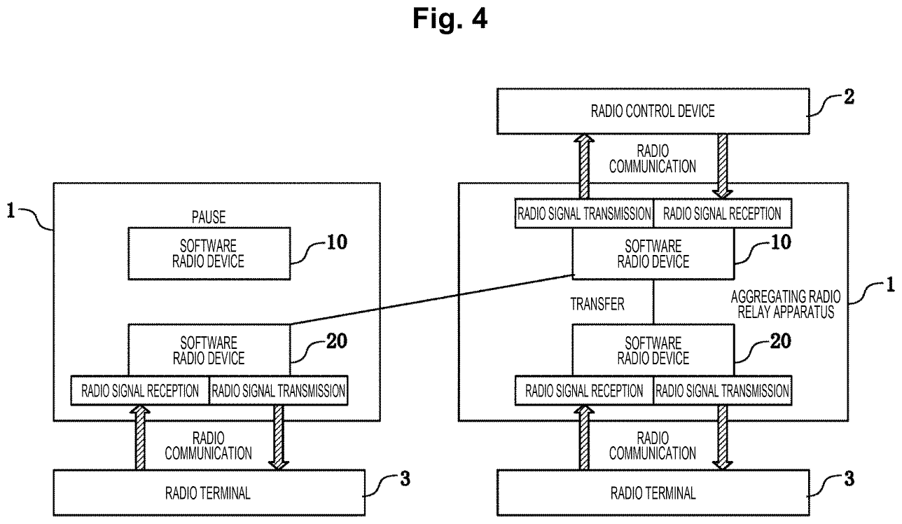

FIG. 4 is a diagram schematically illustrating an operation of the radio relay system 100 in the low power consumption function in Embodiment 1. During the operation in the low power consumption function, the first software radio device 10 and the second software radio device 20 included in the radio relay apparatus 1 that is not the aggregating radio relay apparatus are disconnected from each other. When the transfer destination control unit 19 and the transfer destination control unit 29 are activated, the first software radio device 10 included in the aggregating radio relay apparatus and the second software radio device 20 included in the radio relay apparatus 1 that is not the aggregating radio relay apparatus are connected by a high-speed line, for example, a wire. As a result, the data signal is transferred between the second software radio device 20 included in the radio relay apparatus 1 that is not the aggregating radio relay apparatus and the first software radio device 10 included in the aggregating radio relay apparatus.

According to this embodiment, it is possible to stop the operation of the first software radio device 10 of the radio relay apparatus 1 that is not the aggregating radio relay apparatus under a predetermined condition such as nighttime when the communication traffic is small. Consequently, power consumption can be efficiently suppressed. Further, each function of the radio relay system 100 (wireless relay system) and the radio relay apparatus constituting the radio relay system 100 can also be realized as a wireless relay method.

In addition, the aggregating radio relay apparatus may further include a communication control unit 19a that performs control to reduce a dedicated bandwidth by changing a modulation scheme of radio communication between the first software radio device 10 included in the aggregating radio relay apparatus and the radio control device 2 to a modulation scheme having a smaller number of symbols. The monitor unit 13 activates the communication control unit 19a when a predetermined condition is satisfied. The communication control unit 19a is mounted on the first software radio device 10, for example.

By reducing the dedicated bandwidth, a cover area in the same area can be widened. consequently, the number of operating radio relay apparatuses 1 can be reduced. For example, the radio relay apparatus 1 that is not the aggregating radio relay apparatus can be caused to come into a dormant state. According to this example, it is possible to improve communication frequency utilization efficiency and further reduce power consumption.

Similarly, the aggregating radio relay apparatus may further include a communication control unit 29a that performs control to reduce a dedicated bandwidth by changing a modulation scheme of radio communication between the second software radio device 20 included in the aggregating radio relay apparatus and the radio terminal 3 to a modulation scheme having a smaller number of symbols. The communication control unit 29a is activated when a predetermined condition is satisfied. The activation of the communication control unit 29a is performed by, for example, a monitor unit having a monitoring function such as the monitor unit 13 or the monitor unit 23. The communication control unit 29a is mounted on the second software radio device 20, for example. According to this example, it is possible to improve communication frequency utilization efficiency and further reduce power consumption.

### INDUSTRIAL APPLICABILITY

The wireless relay system, the wireless relay method, and the software radio devices according to the present invention can be applied to various types of radio communication.

### REFERENCE SIGNS LIST

1 Radio relay apparatus
2 Radio control device
3 Radio terminal
10 Software radio device
11 Transceiver
11a Reception unit
11b Transmission unit
12 Control unit
13 Monitor unit
14 Synchronous word identifying unit
15 Storage area
16 Switch determining unit
17 Capture unit
18 Communication unit
19 Transfer destination control unit
19a Communication control unit
20 Software radio device
21 Transceiver
21a Reception unit
21b Transmission unit
22 Control unit
23 Monitor unit
24 Synchronous word identifying unit
25 Storage area
26 Switch determining unit
27 Capture unit
28 Communication unit
29 Transfer destination control unit
29a Communication control unit
100 Radio relay system (Wireless relay system)

1. A wireless relay system comprising:
a plurality of radio relay apparatuses that relays radio communication,
wherein the radio relay apparatus includes a first software radio device that performs radio communication with a radio control device and a second software radio device that performs radio communication with a radio terminal which is under control of the radio control device,
wherein the first software radio device captures, as iq data, a radio signal received from the radio control device, transfers the captured iq data to the second software radio device in real time, converts the iq data transferred from the second software radio device into a radio signal, and transmits the radio signal to the radio control device,
wherein the second software radio device captures, as iq data, a radio signal received from the radio terminal, transfers the captured iq data to the first software radio device in real time, converts the iq data transferred from the first software radio device into a radio signal, and transmits the radio signal to the radio terminal,
wherein the plurality of radio relay apparatuses includes an aggregating radio relay apparatus and a radio relay apparatus other than the aggregating radio relay apparatus,
wherein the aggregating radio relay apparatus includes a first transfer destination control circuitry that controls the first software radio device included in the aggregating radio relay apparatus to transfer a data signal to and from the second software radio device included in the other radio relay apparatus that is not the aggregating radio relay apparatus, and a first monitor circuitry that activates the first transfer destination control circuitry when a predetermined condition is satisfied, and
wherein the radio relay apparatus that is not the aggregating radio relay apparatus includes a second transfer destination control circuitry that controls the second software radio device included in the radio relay apparatus to transfer a data signal to and from the first software radio device included in the aggregating radio relay apparatus, instead of the first software radio device included in the radio relay apparatus that is not the aggregating radio relay apparatus, and a second monitor circuitry that activates the second transfer destination control circuitry when a predetermined condition is satisfied.

2. The wireless relay system according to claim 1,
wherein the aggregating radio relay apparatus further includes a first communication control circuitry that performs control to reduce a dedicated bandwidth by changing a modulation scheme of radio communication between the first software radio device included in the aggregating radio relay apparatus and the radio control device to a modulation scheme having a smaller number of symbols, and
wherein the first monitor circuitry activates the first communication control circuitry when a predetermined condition is satisfied.

3. The wireless relay system according to claim 1,
wherein the aggregating radio relay apparatus includes
a second communication control circuitry that performs control to reduce a dedicated bandwidth by changing a modulation scheme of radio communication between the radio terminal and the second software radio device included in the aggregating radio relay apparatus to a modulation scheme having a smaller number of symbols, and
a monitor circuitry that activates the second communication control circuitry when a predetermined condition is satisfied.

4. A wireless relay method comprising:
capturing, as iq data, a radio signal received by a first software radio device from a radio control device and transferring the captured iq data to a second software radio device in real time;
capturing, as iq data, a radio signal received by the second software radio device from a radio terminal which is under control of the radio control device and transferring the captured iq data to the first software radio device in real time;
converting the iq data transferred to the second software radio device into a radio signal and transmitting the radio signal to the radio control device;
converting the iq data transferred to the first software radio device into a radio signal and transmitting the radio signal to the radio terminal;
controlling the first software radio device included in an aggregating radio relay apparatus among a plurality of radio relay apparatuses to transfer a data signal to and from the second software radio device included in the other radio relay apparatus that is not the aggregating radio relay apparatus, when a predetermined condition is satisfied; and
controlling the second software radio device included in the radio relay apparatus that is not the aggregating radio relay apparatus to transfer a data signal to and from the first software radio device included in the aggregating radio relay apparatus instead of the first software radio device included in the radio relay apparatus that is not the aggregating radio relay apparatus when a predetermined condition is satisfied.
